(19) United States
(12) Patent Application Publication
(10) Pub. No.: US 2006/0141208 A1
(43) Pub. Date: Jun. 29, 2006

(54) Glass run

(75) Inventors: Tomohiro Takase, Aichi-ken (JP); Masanori Aritake, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI Co., Ltd., Aichi-ken (JP)

(21) Appl. No.: 11/313,944

(22) Filed: Dec. 22, 2005

(30) Foreign Application Priority Data
Dec. 28, 2004 (JP) 2004-378450

(51) Int. Cl. B32B 3/04

(52) U.S. Cl. 428/122

(57) ABSTRACT

A glass run is made from TPO and includes a main body and a pair of sealing lips. The main body is provided with a base portion, exterior and interior side wall portions which both extend from the base portion. Parts of the glass run corresponding to vertical side parts of a door glass opening are extruded such that portions of the sealing lips for contacting with a door glass are covered by lip sliding portions. The lip sliding portions are made from an olefin composition compounded of polyolefin resin beads. At least a portion of the base portion for contacting with an edge of the door glass is covered by a base sliding portion. The base sliding portion is made from an olefin composition which is harder than the base portion and is not compounded of the resin beads.

### BACKGROUND OF THE INVENTION

1. Field of the Invention

The present invention relates to a glass run.

2. Related Art

Generally, a glass run is provided along a peripheral part of a door glass opening in an automobile. The glass run is provided with extruded portions which are extruded substantially linearly (into elongated shapes) and molded portions which connect the extruded portions to each other in such a state that the extruded portions so connected form a predetermined angle therebetween and is constituted, for example, by a front vertical side part, an upper side part and a rear vertical side part so as to follow the shape of the door glass opening. In addition, when viewed from a direction of its cross section, the glass run has a main body provided with a base portion and a pair side wall portions which extend from the base portion toward an inner face of the door glass opening and formed substantially into a U-shape and a pair of sealing lips which extend substantially from distal parts of the side wall portions into an inside of the main body. The glass run is mounted in a door sash at the main body, whereby internal and exterior sides of a door glass are sealed by the pair of sealing lips.

Note that ethylene-α-olefin non-conjugated diene copolymer (EPDM), olefin thermoplastic elastomer (TPO) and the like are known as materials making up such glass runs.

Incidentally, since the base portion and the sealing lip portions of the glass run are brought into sliding contact with the door glass when the door glass is opened and closed, there exists a need to suppress a wear caused by the moving door glass. To cope with this, there exists a technique in which a sliding portion which is harder than the base portion and the sealing lip portions are provided on surfaces of the base portion and the sealing lips which are brought into sliding contact with the door glass so as to increase the durability of the glass run (for example, refer to Japanese Patent Publication JP H11-342751A).

In JP H11-342751A, however, while the increase in wear resistance is realized, there still remains a room for improvement in attempting to make the door glass move more smoothly. In particular, it is desired to effectively suppress noise that may be caused by the moving door glass particularly at the sealing lip portions.

### SUMMARY OF THE INVENTION

The invention was made in view of the aforesaid situations and an object thereof is to provide a glass run which can suppress the generation of noise attributed to the moving of the door glass.

Hereinafter, some aspects of the invention which are suitable for attaining the object will be itemized for description below. Note that a function and advantage inherent in the aspects of the invention so itemized will be added as required after each description.

(1) One aspect of the invention provides a glass run, adapted to be mounted in a peripheral part of a door glass opening in a vehicle, including:

a main body provided with a base portion and a pair of side wall portions extending from the base portion so that the main body has a substantially U-shaped cross section; and

a pair of sealing lips which extend from distal parts of the side wall portions into an inside of the U-shaped main body;

wherein the main body and the sealing lips are made from an olefin thermoplastic elastomer, and

a lip sliding portion made from an olefin composition in which polyolefin resin beads are included is provided on at least a part of the sealing lips where interior or exterior surface of a door glass is to be brought into sliding contact, and

a base sliding portion made from an olefin composition which is harder than the base portion and does not include the resin beads is provided on at least a portion of the base portion which is to be brought into sliding contact with an end portion of the door glass.

According to the aspect (1), since the polyolefin resin beads are compounded into the lip sliding portion, the resin beads are exposed from surfaces of the sealing lips or irregular surfaces attributed to the resin beads are formed on the sealing lips. Due to this, when the door glass is moving between the sealing lips, the sealing lips and the door glass come into a so-called point contact with each other. Consequently, the frictional resistance brought about between both the members can be reduced, whereby the door glass is allowed to move smoothly. As a result, noise that would otherwise be caused by the moving door glass can effectively suppressed.

In addition, the base sliding portion is made of the material that is harder than the base portion. Due to this, when compared with a case where the door glass moves on the base portion on which the base sliding portion is not provided, the wear resistance can be increased. Furthermore, since no resin beads are compounded into the base sliding portion, even when a large stress is exerted on the base sliding portion, it is possible to prevent the occurrence of a situation where the resin beads are dislodged from the base sliding portion. As a result, the wear attributed to the moving of the door glass can effectively suppressed, thereby making it possible to increase the durability of the glass run.

On top of this, since the main body and the sealing lips are made of the olefin thermoplastic elastomer (TPO), the base sliding portion and the lip sliding portions which are made from the olefin compositions can be rigidly strongly joined (thermally joined) to the main body and the sealing lip portions, respectively. Consequently, the occurrence of a risk can be prevented that the base sliding portion and the lip sliding portions are separated from the main body and the sealing lip portions, respectively. In addition, for example, when attempting to form the main body and the sealing lips from ethylene-α-olefin non-conjugated diene copolymer (EPDM) or the like, while a vulcanizing process is necessary, such a vulcanizing process is not required in the aspect (1). Consequently, the occurrence of a drawback can be suppressed that the resin beads are melted by heat generated during vulcanization, and hence the particle shape of the resin beads can be maintained, the aforesaid functions and advantages being thereby provided in an ensured fashion.

Additionally, since the sealing lips and the main body are simultaneously extruded in such a state that the sealing lips and the main body are covered by the lip sliding portions and the base sliding portion, respectively, no separate post process is required, and as a result, the reduction in working efficiency and increase in production costs can be suppressed.

(2) One aspect of the invention provides a glass run, wherein the resin bead is made of an ultra high molecule weight polyethylene with an average molecular weight of a million to five million or a high density polyethylene with an average molecular weight of three hundred thousand to a million.

According to the aspect (2), a risk that the resin beads are fused in a manufacturing process can be eliminated by adopting the ultra high molecular weight polyethylene or the high density polyethylene as the resin beads, thereby making it possible to maintain the particle shape of the resin beads in a more ensured fashion.

(3) One aspect of the invention provides a glass run, wherein a particle diameter of the resin beads is in a range of 15 μm to 30 μm, and wherein the resin beads are included into the lip sliding portion by 40 to 60% by weight.

By setting the particle diameter and loadings of the resin beads to those described in the aspect (3), the sealing lips and the door glass can be brought into point contact with each other so as to realize a smooth moving of the door glass, thereby a sufficient sealing capability being ensured. In addition, in the event that the particle diameter is less than 15 μm or exceeds 30 μm, there may occur a risk that a smooth moving is not ensured. Additionally, in the event that the loadings of the resin beads are less than 40% by weight, there may occur a risk that the resin beads are not exposed from the surfaces of the lip sliding portions or that the irregular surfaces attributed to the resin beads does not emerge thereon, whereas in the event that the loadings of the resin beads exceed 60% by weight, there may occur a risk that the resin beads are dislodged from the lip sliding portions.

(4) one aspect of the invention provides a glass run, wherein the lip sliding portion is made harder than the sealing lips.

According to the aspect (4), the wear resistance of the lip sliding portion can be increased, and as a result, the durability of the glass run can be increased.

(5) one aspect of the invention provides a glass run, wherein the base sliding portion is made harder than the lip sliding portion.

When the door glass moves, a larger stress than a stress exerted on the sealing lips which are brought into sliding contact with the external and internal surfaces of the door glass is exerted on the base portion which is brought into sliding contact with the peripheral edge of the door glass. Due to this, a higher wear resistance than one required at the sealing lips is required at the base portion. Since one of the sealing lips needs to secure the sealing characteristic, more flexibility and elasticity are required at the sealing lip than at the base portion. Note that the base sliding portion may be made so as to have a shore hardness D of 45° to 60° and the lip sliding portion a shore hardness D of 40° to 55°. In addition, the thickness of the base sliding portion may be made larger than the thickness of the lip sliding portion.

(6) One aspect of the invention provides a glass run, wherein an exterior side wall sliding portion made of an olefin composition which is harder than an exterior one of the side wall portions and does not includes the resin beads is provided on an inner wall surface of the exterior side wall portion.

In general, in an attempt to realize a flush surface of the door glass with the vehicle body, the door glass is made to be close to an exterior side of the sash when in a closed state. Due to this, a larger stress than one exerted on the inner wall surface of the interior side wall portion is exerted on the inner wall surface of the exterior side wall portion when the door glass moves, and hence the exterior side wall portion is the to be easily worn. In this respect, according to the aspect (6), since the exterior side wall sliding portion is provided, the wear resistance at the inner wall surface of the exterior side wall portion can be increased, and as a result, the durability of the glass run can be increased.

(7) One aspect of the invention provides a glass run, wherein an interior side wall sliding portion made of an olefin composition which includes the resin beads is provided on an inner wall surface of an interior one of the side wall portions.

According to the aspect (7), by providing the internal wall sliding portion compounded of the resin beads on the inner wall surface of the interior side wall portion, the occurrence of a risk can be suppressed that a noise is generated due to the inner wall surface of the interior side wall portion being brought into sliding contact with the sealing lip.

(8) One aspect of the invention provides a glass run, wherein the lip sliding portion and the base sliding portion are formed along a part of the glass run which corresponds to a side part of the peripheral part of the door glass opening.

(9) One aspect of the invention provides a glass run, wherein the main body is mounted on an inner face of a sash provided along the door glass opening.

(10) One aspect of the invention provides a glass run, wherein the sealing lips and the main body are simultaneously formed by extrusion such that the sealing lips and the main body are covered by the lip sliding portion and the base sliding portion, respectively.

According to the aspect (10), the increase in the number of manufacturing processes of the glass run can be suppressed.

### BRIEF DESCRIPTION OF THE DRAWINGS

FIG. 1 is an exemplary front view which schematically shows the configuration of a door;

FIG. 2 is a cross-sectional view taken along the line II-II in FIG. 1, which shows a glass run;

FIG. 3 is a cross-sectional view which shows the glass run in such a state that a door glass opening is closed; and

FIG. 4 is a cross-sectional view which shows a glass run according to another embodiment of the invention.

### DETAILED DESCRIPTION OF THE PREFERRED EMBODIMENTS

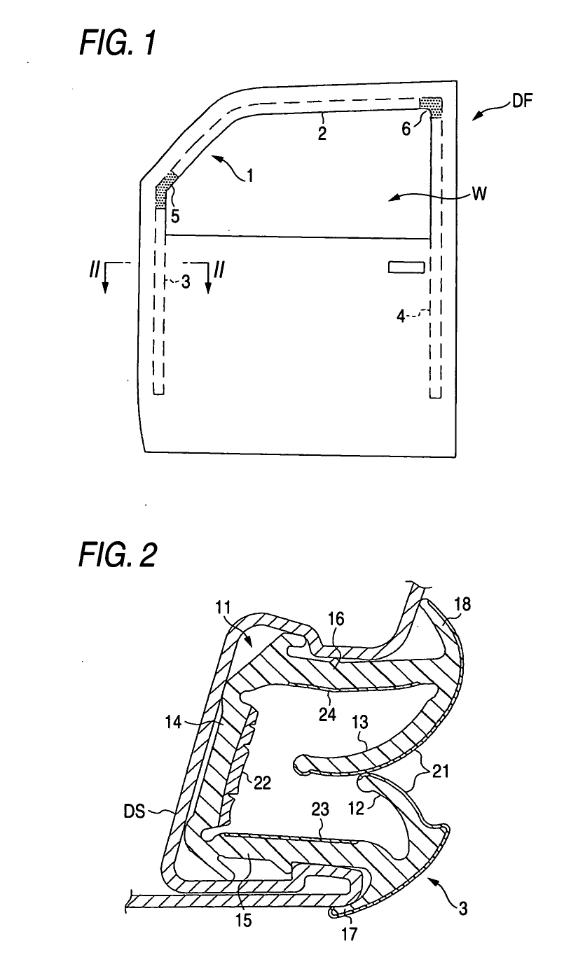

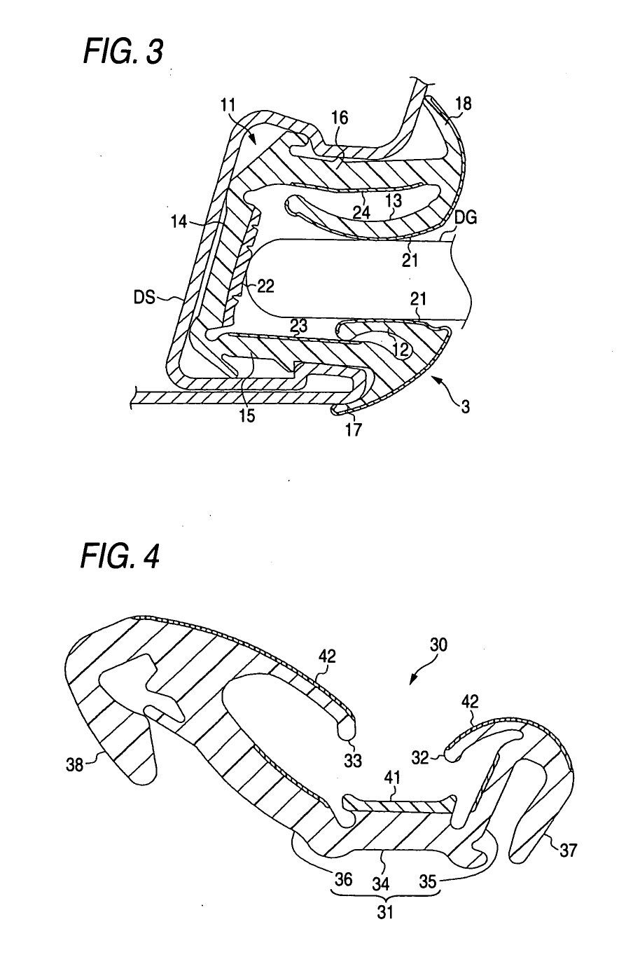

An embodiment of the invention will be described below by reference to the drawings. FIG. 1 is an exemplary front view which schematically shows the configuration of a door. FIG. 2 is a cross-sectional view of a glass run taken along the line II-II in FIG. 1 which shows the configuration of the glass run. FIG. 3 is a partial cross-sectional view which shows the glass run in such a state that a door glass opening is closed.

A glass run is mounted along an outer periphery of a door glass opening in an automotive door. To describe in greater detail, as shown in FIGS. 1, 2, a sash DS is provided on a door DF in such a manner as to follow an outer peripheral shape of the door DF, and a door glass opening W is defined by the sash DS which is to be opened and closed by a door glass adapted to ascend and descend in the sash DS. Then, a glass run 1 is mounted on an inner face of the sash DS.

Firstly, a schematic configuration of the glass run 1 will be described. As shown in FIG. 1, the glass run is made from TPO and is, as shown in a longitudinal direction thereof, divided into an extruded portion 2 which corresponds to an upper side part, extruded portions 3, 4 which correspond to front and rear vertical side parts, respectively, and molded portions 5, 6 (portions shaded with scattered dots in FIG. 1) which connect, respectively, end portions of the two extruded portions 2, 3 and end portions of the two extruded portions 2, 4. The respective extruded portions 2 to 4 are formed substantially rectilinearly (into an elongated shape) by an extruding machine, not shown. In addition, the molded portions 5, 6 are connected and molded, respectively, to the two extruded portions 2, 3 and the two extruded portions 2, 4 in a mold, not shown, in such a manner that the respective two extruded portions 2, 3 and 2, 4 are connected to each other in such a state that predetermined angles are formed therebetween. Note that a main body 11 and sealing lips 12, 13 in this embodiment are made from TPO (70% by weight of rubber portion: 30% by weight of resin portion), and their shore hardness A ranges from 50° to 90°. By this configuration, while the installation characteristic onto the sash DS and fitted state holding characteristic in the sash DS of the glass run 1 are maintained, the sealing characteristic and durability of the sealing lips 12, 13 can be secured.

As shown in FIG. 2, the extruded portion 3 includes a main body 11 and a pair of sealing lips 12, 13. The main body 11 is provided with a base portion 14 which is fitted in the sash DS and an exterior side wall portion 15 and an interior side wall portion 16 which extend from the base portion 14. When opening and closing a door glass DG, an end edge of the door glass DG is made to be brought into sliding contact with an inner surface of the base portion 14 (refer to FIG. 3). In addition, the sealing lips 12, 13 extend substantially from distal parts of both the side wall portions 15, 16 toward an inside (toward the base portion 14) of the main body 11, respectively. In such a state that the door glass opening W is closed, an external surface (a surface which faces an inner side of the door glass opening W) of the sealing lip 12 is brought into press contact with an external surface of the door glass DG, and an external surface of the sealing lip 13 is brought into press contact with an internal surface of the door glass DG (refer to FIG. 3), whereby the exterior side and interior side of the door glass DG are sealed. In addition, in this embodiment, there are provided an external decorative lip 17 which extends transversely outward (to an outside of the vehicle) from the exterior side wall portion 15 and an internal decorative lip 18 which extends transversely outward (to an inside of the vehicle) from the interior side wall portion 16. Note that the extruded portions 2, 4 and the molded portions 5, 6 also include the main body 11 and the pair of sealing lips 12, 13.

Incidentally, in this embodiment, a covering processing is implemented on surfaces of the extruded portions 2, 3, 4 which are brought into contact with the door glass G (door glass sliding surfaces). The door glass sliding surfaces will be described below by reference to the drawings.

As shown in FIGS. 2, 3, lip sliding portions 21 of 100 μm thick are provided on the external surfaces of the sealing lips 12, 13 which constitute the door glass sliding surfaces. In addition, a base sliding portion of 500 μm thick is provided on the inner surface of the base portion which constitutes the door sliding surface. Furthermore, on the main body 11, side wall sliding portions 23, 24 are provided on inner wall surfaces of the exterior side wall portion 15 and the interior side wall portion 16. In this embodiment, the main body 11 and the sealing lips 12, 13 are formed simultaneously by extrusion in such a state that the main body 11 and the sealing lips 12, 13 are covered by the sliding portions 21, 22, 23, 24, respectively, whereby the increase in the number of manufacturing processes of the glass run 1 can be suppressed.

The lip sliding portions 21 and the side wall sliding portion 24 of the inside side wall portion 16 (the inside sidewall sliding portion) are made from a composition that is constituted by 42 to 48% by weight (for example, 47% by weight) of TPO (40% by weight of rubber portion: 60% by weight of resin portion), 3 to 5% by weight (for example, 5% by weight) of silicone oil, 1.5 to 2% by weight (for example, 2% by weight) of fatty amide and 45 to 50% by weight (for example, 46% by weight) of resin beads made from an ultra high molecular weight polyethylene (whose average molecular weight is three million in this embodiment) and having a particle diameter of 20 μm. In addition, the composition that is compounded as has been described just above or the lip sliding portions 21 and the side wall sliding portion 24 are made to have a shore hardness D ranging from 40° to 55°. In addition, since the ultra high molecular weight polyethylene, which constitutes the material of the resin beads, are not fused even in a heated state brought about when compounded and during extrusion, the particle shape of the resin beads is made to be maintained even after extrusion. Additionally, the surfaces of the lip sliding portions 21 and the side wall sliding portion 24 are formed into minutely irregular surfaces due to the resin beads being exposed from the surfaces of the relevant sliding portions.

On the other hand, the base sliding portion 22 and the side wall sliding portion 23 of the exterior side wall portion 15 (the exterior side wall sliding portion) are made from a composition that is constituted by 90 to 95% by weight (for example, 93% by weight) of TPO (40% by weight of rubber portion: 60% by weight of resin portion), 3 to 5% by weight (for example, 5% by weight) of silicone oil and 1.5 to 2% by weight (for example, 2% by weight) of fatty amide and is not compounded of the resin beads. In addition, the composition that is compounded as has been described just above or the base sliding portion 22 and the side wall sliding portion 23 are made to have a shore hardness D ranging from 45° to 60°. Note that a slit which extends along a longitudinal direction of the extruded portion 3 (2, 4) is formed in a surface of the base sliding portion 22, whereby foreign matters such as sand and dust are allowed to enter the slit before they stick to the surface of the base sliding portion (the base portion 14) or foreign matters sticking to the surface of the base sliding portion 22 are removed therefrom through the slit as the door glass DG vibrates laterally. Due to this, the occurrence of a risk can be suppressed that a noise is generated when the door glass DG is brought into sliding contact with the base portion 14.

Thus, as has been described heretofore, in the embodiment, the lip sliding portions 21 compounded of the polyolefin resin beads are provided on the external surfaces of the sealing lips 12, 13. Due to this, the resin beads are exposed from the surfaces of the sealing lips 12, 13, or the irregular surfaces attributed to the resin beads are formed on the surfaces of the sealing lips 12, 13. This allows the sealing lips 12, 13 and the door glass DG to be brought into point contact with each other when the door glass DG is opened and closed. Consequently, the frictional resistance between both the members can be reduced, whereby the door glass DG is allowed to move smoothly. As a result, the generation of noise attributed to the opening and closing of the door glass DG can effectively be suppressed.

In addition, the base sliding portion 22 (whose shore hardness D ranges from 45° to 60°) is made from the material which is harder than the base portion 14 (whose shore hardness A ranges from 50° to 90°). Due to this, the wear resistance can be increased compared with a case where the door glass is brought into sliding contact with the base portion on which the base sliding portion 22 is not provided. Furthermore, since the resin beads are not compounded into the base sliding portion 22, even in the event that a large stress is exerted on the bases sliding portion 22, the occurrence of a case can be prevented in which the resin beads are dislodged from the base sliding portion 22. As a result, the wear attributed to the moving of the door glass DG can effectively be suppressed, thereby making it possible to increase the durability of the glass run 1.

On top of this, since the main body 11 and the sealing lips 12, 13 are made from TPO, the base sliding portion 22 and the lip sliding portions 21 which are made from the olefin compositions can be rigidly strongly joined (thermally joined) to the main body 11 and the sealing lips 12, 13. Consequently, the occurrence of a risk can be prevented that the base sliding portion 22 and the lip sliding portions 21 are separated from the main body 11 and the sealing lips 21, respectively. In addition, for example, when attempting to form the main body 11 and the sealing lips 12, 13 from ethylene-α-olefin non-conjugated diene copolymer (EPDM) or the like, while a vulcanizing process is necessary, such a vulcanizing process is not required in this embodiment. Consequently, the occurrence of a drawback can be suppressed that the resin beads are melted by heat generated during vulcanization, and hence the particle shape of the resin beads can be maintained, the aforesaid functions and advantages being thereby provided in an ensured fashion.

Furthermore, by adopting the ultra high molecular weight polyethylene with an average molecular weight of three million, a risk can be eliminated that the resin beads are fused during the manufacturing process, thereby making it possible to ensure that the particle shape of the resin beads is retained. Furthermore, the resin beads whose particle diameter is 20 μm is compounded into the composition making up the lip sliding portion 21 by 45 to 50% by weight, whereby the sealing lips 12, 13 and the door glass DG are allowed to be brought into point contact with each other, so that the smooth moving of the door glass DG can be realized, thereby making it possible to ensure that a sufficient sealing capability can be secured.

In addition, since the sealing lips 12, 13 and the main body 11 are extruded simultaneously in such a state that the sealing lips 12, 13 and the main body 11 are covered by the lip sliding portions 21 and the base sliding portion 22, respectively, no separate post process is necessary, and as a result, the reduction in working efficiency and increase in production costs can be suppressed.

On top of this, since the lip sliding portions 21 (whose shore hardness D ranges from 40° to 55°) is made harder than the sealing lips 12, 13 (whose shore hardness A ranges from 50° to 90°), the wear resistance of the lip sliding portions 21 can be increased, and as a result, the durability of the glass run 1 can be increased.

Furthermore, the base sliding portion 22, to which a larger stress than one that is to be exerted on the lip sliding portions 21 from the door glass DG when it is opened and closed, is made harder and thicker than the lip sliding portions 21, whereby the wear resistance of the glass run 1 can effectively be increased while securing the sealing characteristics of the sealing lips 12, 13.

In addition, the wear resistance of the inner wall surface of the exterior side wall portion 15 can be increased by providing the side wall sliding portion 23 on the inner wall surface of the exterior side wall portion 15, and as a result, the wear resistance of the glass run 1 can be increased. Furthermore, a risk that noise is produced due to the inner wall surface of the interior side wall portion 16 and the sealing lip 12 being brought into sliding contact with each other can be suppressed by providing the side wall sliding portion 24 compounded of the resin beads on the inner wall surface of the interior side wall portion 16.

Note that the invention is not limited to what has been described heretofore with respect to the embodiment but may be embodied as follows. Other applications and modifications than those described below will, of course, be possible.

(a) As shown in FIG. 4, the aforesaid configuration may be adopted for a glass run 30 including a main body 31 provided with a base portion 34 and a pair of side wall portions 35, 36 which extend from the base portion 34 and formed substantially into a V-shaped cross section, sealing lips 32, 33 which extend from distal parts of both the side wall portions 35, 36 into an inside of the main body 31, and lips 37, 38 which extend outward from the distal parts of both the side wall portions 35, 36 and adapted to be fitted in a sash by holding the sash between the lips 37, 38 and both the side wall portions 35, 36, respectively, in such a state that both the side wall portions 35, 36 are brought closer to each other so as to be positioned substantially in parallel with each other. Namely, a base sliding portion 41 may be provided on a glass sliding surface of the base portion 34, and lip sliding portions 42 may be provided on glass sliding surfaces of the sealing lips 32, 33.

(b) While, in the embodiment, the base sliding portion 22 and the lip sliding portions 21 are configured to be provided on any of the extruded portions 2, 3, 4, these sliding portions 21, 22 may be omitted on the extruded portion 2. In this case, a damping device may be provided on the base portion 14. In addition, the extruded portion 2 may be made from EPDM.

(c) The resin beads in the embodiment does not always have to be made from the ultra high molecular weight polyethylene but may be made from a high density polyethylene with an average molecular weight of three hundred thousand to one million.

(d) While, in the embodiment, the slit is formed in the base sliding portion 22, the slit may be omitted. In addition, a slit extending in a longitudinal direction of the extruded portion 3 (2, 4) may also be formed in the side wall sliding portion 23 of the exterior side wall portion 15.

(e) While, in the embodiment, the glass run 1 is embodied on which both the external decorative lip 17 and internal decorative lip 18 are provided, the invention can be applied to a glass run in which at least either of the lips is omitted.

What is claimed is:

1. A glass run, adapted to be mounted in a peripheral part of a door glass opening in a vehicle, comprising;
a main body provided with a base portion and a pair of side wall portions extending from said base portion so that said main body has a substantially U-shaped cross section; and
a pair of sealing lips which extend from distal parts of said side wall portions into an inside of said U-shaped main body;
wherein said main body and the sealing lips are made from an olefin thermoplastic elastomer, and
a lip sliding portion made from an olefin composition in which polyolefin resin beads are included is provided on at least a part of the sealing lips where interior or exterior surface of a door glass is to be brought into sliding contact, and
a base sliding portion made from an olefin composition which is harder than said base portion and does not include the resin beads is provided on at least a portion of said base portion which is to be brought into sliding contact with an end portion of the door glass.

2. A glass run according to claim 1, wherein said resin beads are made of an ultra high molecule weight polyethylene with an average molecular weight of a million to five million or a high density polyethylene with an average molecular weight of three hundred thousand to a million.

3. A glass run according to claim 1, wherein a particle diameter of said resin beads is in a range of 15 μm to 30 μm, and wherein said resin beads are included into said lip sliding portion by 40 to 60% by weight.

4. A glass run according to claim 1, wherein said lip sliding portion is made harder than said sealing lips.

5. A glass run according to claim 1, wherein said base sliding portion is made harder than said lip sliding portion.

6. A glass run according to claim 1, wherein an exterior side wall sliding portion made of an olefin composition which is harder than an exterior one of said side wall portions and does not includes the resin beads is provided on an inner wall surface of said exterior side wall portion.

7. A glass run according to claim 1, wherein an interior side wall sliding portion made of an olefin composition which includes the resin beads is provided on an inner wall surface of an interior one of said side wall portions.

8. A glass run according to claim 1, wherein said lip sliding portion and said base sliding portion are formed along a part of said glass run which corresponds to a side part of the peripheral part of the door glass opening.

9. A glass run according to claim 1, wherein said main body is mounted on an inner face of a sash provided along the door glass opening.

10. A glass run according to claim 1, wherein said sealing lips and said main body are simultaneously formed by extrusion such that said sealing lips and said main body are covered by said lip sliding portion and said base sliding portion, respectively.
